(19) United States
(12) Patent Application Publication
(10) Pub. No.: US 2026/0189426 A1
(43) Pub. Date: Jul. 2, 2026

(54) MODULAR APPARATUS FOR NETWORK CONNECTIVITY

(71) Applicant: DataRemote, Inc., Miami, FL (US)

(72) Inventor: Christopher Ludewig, Miami, FL (US)

(21) Appl. No.: 19/390,951

(22) Filed: Nov. 17, 2025

Related U.S. Application Data
(60) Provisional application No. 63/738,917, filed on Dec. 26, 2024.

(51) Int. Cl. H04L 12/28; H04L 12/10

(52) U.S. Cl. CPC H04L 12/2898; H04L 12/10

(57) ABSTRACT

A modular apparatus for network connectivity includes a central router; and a first modular separable access point, integrated with a first antenna system The first modular separable access point is configured to be separable and remotely operable from the central router. The central router is configured to provide power over Ethernet to the first modular separable access point.

### CROSS-REFERENCE TO RELATED APPLICATIONS

This application claims the benefit of priority to U.S. provisional application No. 63/738,917, filed Dec. 26, 2024, the contents of which are herein incorporated by reference.

### TECHNICAL FIELD

The present application relates to network gateways and, in particular, to a modular apparatus for internet and wide area network (WAN) connectivity.

### BACKGROUND

As users are relying on increasing amounts of data connectivity, there are demands to have such data connectivity always available, even in the face of wide area network or power failure. Accordingly, there is an interest in improvement via redundant systems.

### SUMMARY

This disclosure relates to an apparatus for internet and power backup.

In accordance with aspects of the present disclosure, a modular apparatus includes a central router; and a first modular separable access point or wireless cellular wide area network (WAN), integrated with a first antenna system. The central router is configured to provide power over Ethernet to the first modular separable access point.

In an aspect of the present disclosure, the first modular separable access point or wireless WAN may include an integrated cellular modem configured for Internet communications.

In an aspect of the present disclosure, the apparatus may further include a second modular separable access points, integrated with a second antenna system.

In an aspect of the present disclosure, the second modular separable access point may include an integrated WiFi® access point or WiFi client radio.

In an aspect of the present disclosure, each of the first and second modular separable access points may include a different type of communication configuration.

In an aspect of the present disclosure, each of the first and second separable access points may be configured for flush mounting.

In an aspect of the present disclosure, the first separable access point may be connected to the router via Ethernet cables, which carry both data and power.

In an aspect of the present disclosure, one of the first or second separable access points may further include a Global Navigation Satellite System (GNSS) receiver configured to monitor geographical location information of the apparatus.

In an aspect of the present disclosure, one of the first or second separable access points may include an attachment point configured for removable attachment of each of the first and second separable access points from the router.

In an aspect of the present disclosure, each of the first and second separable access points may be configured to be attachable to a respective side of the router via a screw centrally located on the respective separable access point.

In an aspect of the present disclosure, the screw may include at least one of a thumb screw or knurled surface.

In an aspect of the present disclosure, the first separable access point may include a snap-on feature that configured for securely clicking the separable access points into place on the router.

In an aspect of the present disclosure, the first separable access point may include a release mechanism configured for removal of each of the separable access points.

In accordance with aspects of the present disclosure, a modular apparatus system including a plurality of modular apparatuses, each including: a central router; and a first modular separable access points, integrated with a first antenna system; and a rack mounting bracket configured for rack mounting the central router of each of the plurality of modular apparatuses. The central router is configured to provide power over Ethernet to the first modular separable access point.

In an aspect of the present disclosure, the first modular separable access point may include an integrated cellular modem configured for Internet communications.

In an aspect of the present disclosure, each of the plurality of modular apparatuses may further include a second modular separable access points, integrated with a second antenna system.

In an aspect of the present disclosure, the second modular separable access point may include an integrated WiFi® access point.

In an aspect of the present disclosure, the rack mounting bracket may include alignment holes or slots configured to receive fasteners securing each central router in a fixed orientation within the rack.

In an aspect of the present disclosure, each central router may include a display configured to present operational status information for the corresponding modular apparatus.

In accordance with aspects of the present disclosure, a modular apparatus includes a central router having a housing that includes at least one mounting surface, and a first modular separable access point integrated with a first antenna system and configured to be removably attachable to the mounting surface of the housing. The first modular separable access point includes a mechanical coupling comprising an alignment guide and a centrally located fastener configured to secure the first modular separable access point to the housing in a substantially flush orientation. The central router is configured to provide power and data to the first modular separable access point through a Power-over-Ethernet connection established upon attachment.

Further details and aspects of exemplary embodiments of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative embodiments, in which the principles of the technology are utilized, and the accompanying drawings of which:

FIG. 1 is a rear view of a modular apparatus for Wide Area Network (WAN) and power backup in accordance with aspects of the present disclosure;

FIG. 2 is a block diagram of a controller of the apparatus of FIG. 1 in accordance with aspects of the present disclosure;

FIG. 3 is a block diagram of the apparatus of FIG. 1 in accordance with aspects of the present disclosure;

FIG. 4 is a diagram of the apparatus of FIG. 1 in accordance with aspects of the present disclosure;

FIG. 5 is a top perspective view of the apparatus of FIG. 1 with one of the separable access points removed in accordance with aspects of the present disclosure;

FIG. 6 is a top perspective view of the apparatus of FIG. 1, mounted to a plate, with two separable access points remotely located in accordance with aspects of the present disclosure;

FIG. 7 is a top-side perspective view of two of the routers of the apparatus of FIG. 1, in a rack-mounted configuration, in accordance with aspects of the present disclosure; and

FIG. 8 is a left perspective view of the apparatus of FIG. 1 where the separable access point is transparent to illustrate an attachment point, in accordance with aspects of the present disclosure.

### DETAILED DESCRIPTION

The present application relates to network gateways and, in particular, to an apparatus for internet and power backup.

For purposes of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Various alterations, rearrangements, substitutions, and modifications of the inventive features illustrated herein, and any additional applications of the principles of the present disclosure as illustrated herein, which would occur to one skilled in the relevant art and having possession of this disclosure, are to be considered within the scope of the present disclosure.

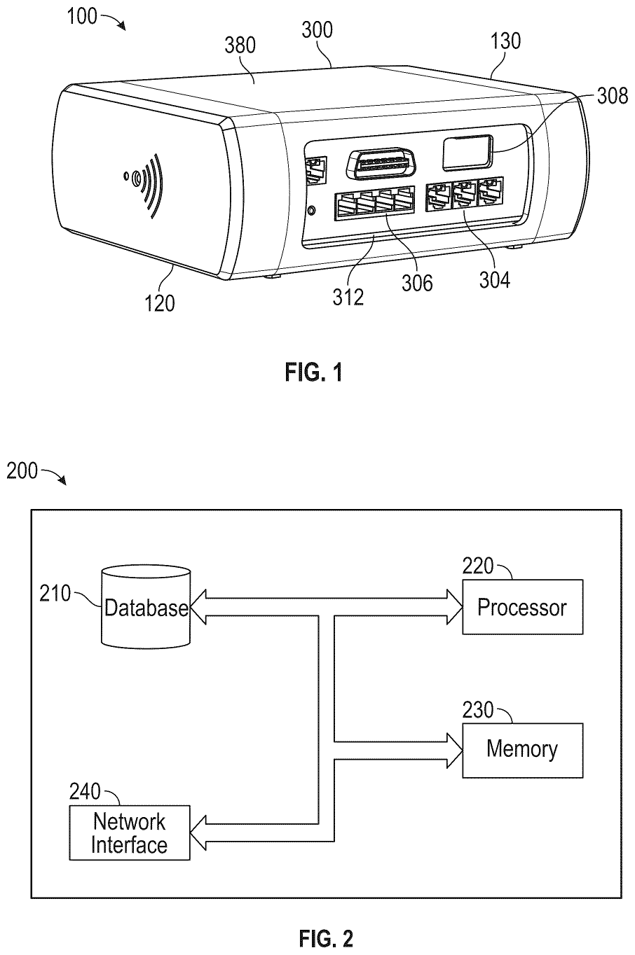

Referring to FIGS. 1-3, an exemplary modular apparatus 100 provides a modular platform for internet and power backup in accordance with aspects of the present disclosure is shown. The modular apparatus 100 generally includes a power source 150 configured for powering the apparatus 100, a battery 140 configured for providing backup power to the apparatus 100, a first switch 310, a sensor 350, a network port 304, such as, for example, a Wide Area Network (WAN) port, a first separable access point 120 (e.g., a cellular modem) configured for network communications, a second separable access point 130 (e.g., a WiFi® transceiver) configured for network communications, a second switch 320, and a controller 200 (FIG. 2).

The modular apparatus 100 features two modular, separable access points 120, 130 (e.g., modems), each integrated with its own antenna system 124, 134. Each separable access point 120, 130 is designed to receive power over Ethernet (PoE), which simplifies setup by reducing the need for separate power cables. The separable access points 120, 130 can either be directly attached to housing 380 of a router 300 (e.g., a central router), or positioned remotely, depending on the user's needs. When attached, the separable access points 120, 130 fit securely and cohesively into designated sides of the router 300, for example, using magnetic or locking mechanisms or other means to ensure a stable connection. These separable access points 120, 130 seamlessly communicate with the router 300 via ethernet, providing high-speed internet connections through integrated antennae, which enhance signal strength and coverage. Router 300 is a networking device that manages data traffic between different networks, such as a local network and the internet. It directs data packets between devices on a local network and external networks, ensuring the data reaches the correct destination. Router 300 may use Network Address Translation (NAT) to allow multiple devices on a local network to share a single public IP address when accessing the internet, while providing a layer of security. Router 300 is configured to assign unique IP addresses to devices, for example, through DHCP, offer wireless connectivity for Wi-Fi-enabled devices, and may include firewall features to protect against unauthorized access. Router 300 may prioritize certain types of traffic to optimize network performance. Separable access points 120, 130 are each configured to be separable and remotely operable from the central router 300.

The separable access points 120, 130 may be flush mounted, providing good access to all connectors, indicators and labels. Flush mounting refers to the installation of each separable access point such that an external surface of the separable access point is substantially coplanar with an outer surface of the router housing 380, without protrusions or recesses. In aspects, “substantially coplanar” may refer to an offset or height difference of less than approximately 0.02 inches, for example between about 0.004 inches and 0.012 inches, measured between adjacent surfaces of the separable access point and the router housing. This configuration enables compact integration and a streamlined form factor that minimizes mechanical interference when the apparatus 100 is installed in confined or shared spaces. Flush mounting also improves airflow across the router housing, enhancing passive thermal dissipation during operation. The smooth external profile reduces the risk of accidental detachment or cable snagging, which can occur in non-flush configurations. Additionally, flush mounting facilitates alignment of connectors and optical indicators on a uniform plane, simplifying assembly and field servicing while improving mechanical stability and aesthetic consistency of the apparatus 100.

Each separable access point 120, 130 may be mounted to the router housing 380 by a mechanical interface that provides both secure attachment and precise alignment of electrical connectors. In aspects, the mounting interface may include a combination of guide rails, alignment pins, or keyed slots formed on the router housing 380, which correspond to complementary grooves or recesses on each separable access point. These features ensure that the separable access point is guided into a defined seated position during installation, preventing lateral or angular misalignment of the electrical contacts. Once positioned, the separable access point may be fastened using a single centrally located fastener, such as a captive thumb screw or knurled screw, or alternately by a spring-loaded latch or snap-fit mechanism. In aspects, the mounting interface may include a magnetic or conductive coupling that assists in retention and ensures full electrical engagement prior to mechanical locking. This combination of guided alignment and single-point fastening enables the benefit of tool-less installation and removal, reduces assembly time, and maintains reliable Power-over-Ethernet and data continuity through repeated cycles of attachment and detachment. The defined mounting geometry also ensures consistent connector engagement depth, reducing mechanical stress on internal cabling and enhancing long-term durability of the apparatus 100. This mounting configuration provides the benefit of allowing rapid field replacement or repositioning of the separable access points without specialized tools, maintaining reliable electrical connectivity, minimizing mechanical wear on connectors, and enabling flexible deployment in variable installation environments.

The modular nature of the separable access points 120, 130 allows them to be detached and repositioned away from the router 300 housing 380, offering greater flexibility in placement. For example, if a user needs to extend coverage to distant areas or overcome interference, they can easily disconnect one or more of the separable access points 120, 130 and mount them in optimal locations. These detachable separable access points 120, 130 are connected to the router 300 via Ethernet cables, which carry both data and power. This configuration allows for extended range and reliable performance, as the PoE setup ensures that each separable access point 120, 130 remains powered without the need for additional power outlets or adapters, and without the need for expensive, low loss radio frequency cables, even when placed far from the central router 300.

The separable access points 120, 130 may include, for example, cellular wide area network (WAN) 122 via cellular connectivity (e.g., 5G RedCap® with LTE fallback), and/or a Wi-Fi® access point 132 or client (e.g., Wi-Fi® 6) configured to extend or create a wireless network without managing the network traffic or assigning IP addresses.

The router 300 may include a display 308 (e.g., a color OLED display) configured to enable monitoring of status of the router 300. For example, display 308 may indicate that the first separable access point 120 is receiving a poor quality network signal.

In aspects, the power source 150 may be an external power supply connected to the apparatus 100 via a power input jack 112.

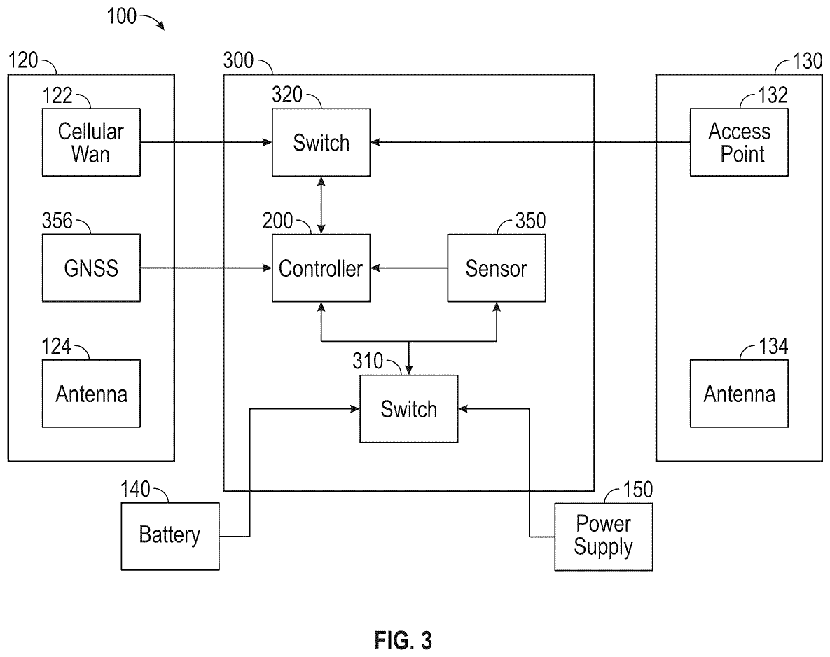

The first switch 310 (FIG. 3) is configured for selectively switching from a first mode where the power source 150 supplies power to the apparatus 100 and a second mode where the battery 140 supplies power to the apparatus 100. The sensor 350 is configured to detect a first signal indicating a presence of power from the power source 150. The sensor 350 is communicatively coupled to the controller 200.

The network port 304 is configured for Internet communications and communicatively coupled to the core router 300. In aspects switching between the primary source and the backup source may at least partially occur within the router 300. The router 300 may include a power input port which is configured to be connected to a power supply 150, such as power output jack.

The second switch 320 (FIG. 3) is configured for selectively switching between a third mode where the internet communications are via the network port 304 and a fourth mode where the internet communications are via the integrated cellular modem 330. The second switch 320 enables automatic failover. The controller 200 (FIG. 2) is responsible for detecting the degradation of quality in network connectivity (e.g., low bandwidth, high latency/jitter, no Internet connectivity, etc.) and for automatically switching over to the integrated cellular modem 330 to maintain network connectivity. The apparatus 100 may further include one or more Foreign Exchange Station (FXS) ports 306 configured for Plain Old Telephone System (POTS) line replacement.

The apparatus 100 may further include a Global Navigation Satellite System (GNSS) receiver 356 configured to monitor geographical location information of the apparatus 100. In aspects, when the FXS ports are being used to provide POTS replacement lines, the controller 200 (FIG. 2) may monitor the geographical location of the apparatus 100 using the GPS receiver 356 and electronically provide the monitored geographical location information of the apparatus 100 when requested by emergency responders. The GPS receiver 356 may be integrated into one or more of the separable access points 120, 130.

Referring now to FIG. 2, exemplary components in the controller 200 in accordance with aspects of the present disclosure include, for example, a database 210, one or more processors 220, at least one memory 230, and a network interface 240.

The database 210 can be located in storage. The term “storage” may refer to any device or material from which information may be capable of being accessed, reproduced, and/or held in an electromagnetic or optical form for access by a computer processor. Storage may be, for example, volatile memory such as RAM, non-volatile memory, which permanently hold digital data until purposely erased, such as flash memory, magnetic devices such as hard disk drives, and optical media such as a CD, DVD, Blu-ray disc, or the like.

The processor 220 executes various processes based on instructions that can be stored in the server memory 230 and utilizing the data from the database 210.

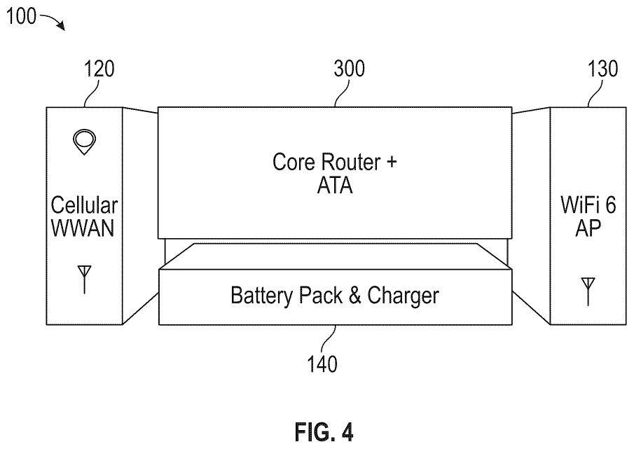

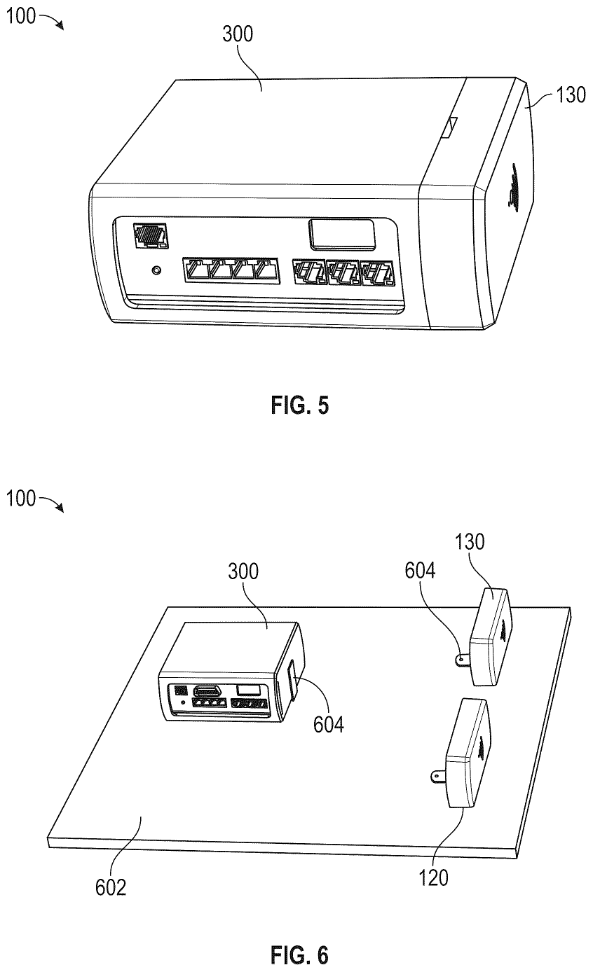

Referring to FIG. 4, the apparatus 100 is shown connected to an internet gateway device (router 300). The router 300 is configured to connect from a network, such as an Internet Service Provider, and route the WAN to the local devices such as local computers.

The apparatus 100 may further include a power output connector 114 configured to electrically couple to the router 300 and provide power to the router 300. In aspects, network may include cable, digital subscriber line, and/or fiber.

FIG. 6 illustrates the apparatus 100 of FIG. 1, mounted to a plate 602, with two separable access points 120, 130 remotely located from the router 300. The separable access point 120, 130 may be connected to the router 300 may be connected to the plate using brackets 604 or any suitable means. The separable access point 120, 130 may be connected to the router 300 via ethernet cable. Router 300 may provide power to each of the separable access points 120, 130 via power over ethernet.

Mounting the router 300 to a plate offers several benefits, particularly in environments where flexibility and stability are important. The mounting plate 602 provides a secure, stable platform for the router 300, preventing it from moving or being accidentally knocked over, which could cause connectivity issues. This is especially important in situations where the router is placed in a location that might experience vibrations or physical disturbances, such as in a vehicle, industrial setting, or non-standard environments. The plate 602 also makes it easier to install or reposition the router 300, offering better accessibility and organization. It helps streamline cable management, as cables can be securely attached to the plate, reducing clutter and minimizing the risk of accidental disconnections. Additionally, mounting the router 300 to the plate 602 can protect the router 300 from dust or other environmental factors, ensuring that the router 300 operates efficiently. Mounting the router 300 to a plate 602 further provides the benefit of easier integration with other equipment or mounting systems, providing a more organized and professional appearance.

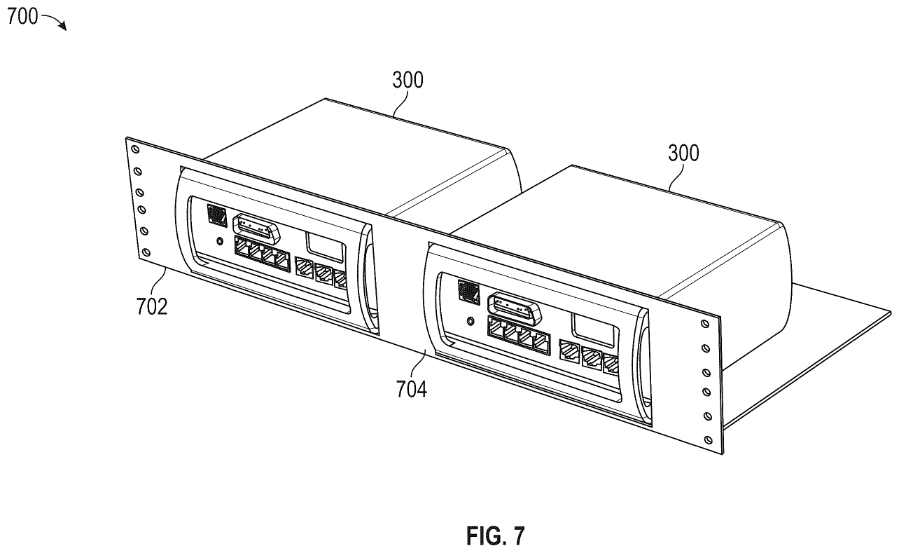

FIG. 7 illustrates a top-side perspective view of two routers 300 of FIG. 1 of an apparatus 700, in a rack-mounted configuration. The apparatus 700 includes a rack mounting bracket 702 that includes holes 704 for accessing the control panel 312 (FIG. 1) of each of the routers 300.

Rack mounting router 300 offers several advantages, particularly in professional or enterprise environments. It helps save space by organizing equipment in a standard rack, allowing for a more efficient use of physical space. This setup also facilitates centralized management, as the router can be easily accessed alongside other networking devices, like switches and servers. Additionally, rack-mounted routers 300 benefit from improved cooling and airflow, which helps prevent overheating. The design of racks often includes cable management systems, reducing clutter and improving organization. Furthermore, rack mounting offers enhanced security by physically securing devices and protecting them from unauthorized access or damage. Rack mounting allows for easy scalability, simplifying the process of adding additional components as the network expands. Rack mounting router 300 provides a professional, organized appearance that is essential for large-scale operations and ensures compatibility with industry-standard 19-inch racks.

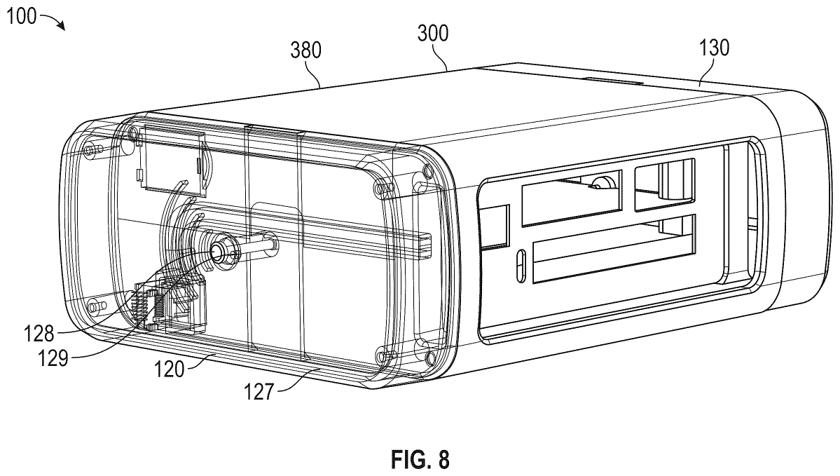

Referring to FIG. 8, a left perspective view of the apparatus of FIG. 1 where the separable access point 120, 130 is shown as transparent to illustrate an attachment point 128. The attachment and detachment process are straightforward, with the separable access points 120, 130 being equipped, for example, with a locking mechanism 129 and/or spring-loaded connectors that allow for quick installation or removal. In aspects, the locking mechanism 129 may include screw(s) that attaches the separable access point 120, 130 to the router 300. For example, the separable access point 120 may be attached using a screw through a hole with a counterbore. The screw may be disposed in the center of the separable access point 120, 130 to provide the benefit of ease of access.

The separable access point 120, 130 and the router 300 may have mating sides that include features on the respective mating surfaces to prevent each of the separable access point 120, 130 from rotating. The screw may hold the respective access point 120, 130 securely in place while allowing for easy attachment and removal. The router 300 (the mounting surface thereof) may include a bracket or slot with a hole, aligned with a corresponding hole on the respective separable access point 120, 130, the screw may be inserted through this hole and threaded into the access point, providing a firm attachment. The screw may include a thumb screw or knurled surface, allowing users to hand-tighten or loosen the screw without tools. The screw may be inserted such that the head of the screw is either flush with an outside surface 127 of the separable access point 120, 130, or below the outside surface 127. Additionally, the screw may be spring-loaded or captive screw to prevent the screw from being lost during removal. This single-screw attachment system offers a stable and secure connection, while still being user-friendly and easy to detach when necessary.

In aspects, the locking mechanism 129 may include a snap-on mechanism that lets users securely click each of the separable access points 120, 130 into place on the router, and a simple release mechanism to remove each of the separable access points 120, 130 when needed.

In aspects, the locking mechanism 129 may enable users to securely attach the separable access points 120, 130 to the router 300 by simply aligning them with designated connectors or slots. This locking mechanism 129 may include small, spring-loaded clips or hooks integrated into the access points and router, enabling a firm yet quick connection when pressed into place. These clips or hooks would “snap” or “click” the access points into position, providing the benefit of ensuring a stable and secure attachment without the need for tools. For release, the mechanism may include a button, lever, and/or latch that disengages the clips or hooks. Pressing or sliding the release mechanism would unlock the access points 120, 130 from the router 300, allowing the access points 120, 130 to be easily removed without excessive force. The design of these attachments and release mechanisms would provide the benefit of both a secure connection during use and easy detachment when needed.

This flexibility makes the router 300 ideal for environments where flexibility, signal range, and performance are paramount, such as large homes, offices, or industrial settings. This apparatus 100 provides the benefit of providing ability to extend or move the separable access points 120, 130 remotely, while maintaining connectivity through Ethernet-powered solutions.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms, or codes may be converted to, or expressed in, a programming language or computer program. No distinction is made between languages that are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood the foregoing description is only illustrative of the present disclosure. Various alternatives and modifications can be devised by those skilled in the art without departing from the present disclosure. Accordingly, the present disclosure is intended to embrace all such alternatives, modifications, and variances. The embodiments described with reference to the attached drawing figures are presented only to demonstrate certain examples of the present disclosure. Other elements, steps, methods, and techniques that are insubstantially different from those described above are also intended to be within the scope of the present disclosure.

What is claimed is:

1. A modular apparatus comprising:
a central router; and
a first modular separable access point or wireless wide area network (WAN), integrated with a first antenna system, configured to be separable and remotely operable from the central router,
wherein the central router is configured to provide power over Ethernet to the first modular separable access point.

2. The modular apparatus of claim 1, wherein the first modular separable access point or wireless WAN includes an integrated cellular modem configured for Internet communications.

3. The modular apparatus of claim 1, further comprising a second modular separable access points, integrated with a second antenna system.

4. The modular apparatus of claim 3, wherein the second modular separable access point includes an integrated WiFi® access point or WiFi client radio.

5. The modular apparatus of claim 3, wherein each of the first and second modular separable access points includes a different type of communication configuration.

6. The modular apparatus of claim 3, wherein each of the first separable access point and second separable access point are configured for flush mounting.

7. The modular apparatus of claim 1, wherein the first separable access point is connected to the router via Ethernet cables, which carry both data and power.

8. The modular apparatus of claim 3, wherein one of the first or second separable access points further includes a Global Navigation Satellite System (GNSS) receiver configured to monitor geographical location information of the apparatus.

9. The modular apparatus of claim 3, wherein one of the first or second separable access points includes an attachment point configured for removable attachment of each of the first and second separable access points from the router.

10. The modular apparatus of claim 3, wherein each of the first and second separable access points is configured to be attachable to a respective side of the router via a screw centrally located on the respective separable access point.

11. The modular apparatus of claim 10, wherein the screw includes at least one of a thumb screw or knurled surface.

12. The modular apparatus of claim 1, wherein the first separable access point includes a snap-on feature that is configured for securely clicking the separable access points into place on the router.

13. The modular apparatus of claim 1, wherein the first separable access point includes a release mechanism configured for removal of each of the separable access points.

14. A modular system comprising:
a plurality of modular apparatuses, each including:
a central router; and
a first modular separable access points, integrated with a first antenna system, configured to be separable and remotely operable from the central router, wherein the central router is configured to provide power over Ethernet to the first modular separable access point; and
a rack mounting bracket configured for rack mounting the central router of each of the plurality of modular apparatuses.

15. The system of claim 14, wherein the first modular separable access point includes an integrated cellular modem configured for Internet communications.

16. The system of claim 14, wherein each of the plurality of modular apparatuses further includes a second modular separable access points, integrated with a second antenna system.

17. The system of claim 16, wherein the second modular separable access point include an integrated WiFi® access point.

18. The system of claim 14, wherein the rack mounting bracket includes alignment holes or slots configured to receive fasteners securing each central router in a fixed orientation within the rack.

19. The system of claim 14, wherein each central router includes a display configured to present operational status information for the corresponding modular apparatus.

20. A modular apparatus comprising:
a central router having a housing that includes at least one mounting surface; and
a first modular separable access point integrated with a first antenna system and configured to be removably attachable to the mounting surface of the housing,
wherein the first modular separable access point includes a mechanical coupling comprising an alignment guide and a centrally located fastener configured to secure the first modular separable access point to the housing in a substantially flush orientation, and
wherein the central router is configured to provide power and data to the first modular separable access point through a Power-over-Ethernet connection established upon attachment.
